(19) United States
(12) Patent Application Publication
(10) Pub. No.: US 2005/0078861 A1
(43) Pub. Date: Apr. 14, 2005

(54) Tomographic system and method for iteratively processing two-dimensional image data for reconstructing three-dimensional image data

(76) Inventor: Daniel A. Usikov, Newark, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/684,000

(22) Filed: Oct. 10, 2003

(51) Int. Cl. G06K 9/00; G21K 1/12

(52) U.S. Cl. 382/131; 382/154; 378/21

(57) ABSTRACT

A tomographic system and method are provided which enable iterative processing of 2D image data for reconstructing 3D image data therefrom. In certain embodiments, a conjugate gradient algorithm is utilized to iteratively process captured 2D image data (e.g., pixels) for reconstructing 3D image data (e.g., voxels) therefrom. In one embodiment, a system for processing 2D image data for reconstructing 3D image data therefrom is provided. The system comprises an imaging system operable to capture a plurality of 2D images at different angles of view. The system further comprises a reconstruction processor communicatively coupled to the imaging system. The reconstruction processor is operable to receive the plurality of captured 2D images and iteratively process the received 2D images to reconstruct 3D image data therefrom in accordance with a conjugate gradient algorithm.

### TECHNICAL FIELD

The present invention relates in general to image processing, and more particularly to a tomographic system and method for processing two-dimensional image data acquired by a radiographic imaging technique, such as cone-beam tomography, to reconstruct three-dimensional image data therefrom, wherein such processing is performed through an iterative technique, such as in accordance with a conjugate gradient method.

### BACKGROUND OF THE INVENTION

The technique of reconstructing a cross-sectional image of an object from multiple projections is broadly referred to as tomography. When such reconstructing of a cross-sectional image is performed with the aid of a processor-based device (or “computer”), the technique is broadly referred to as computed (or computerized) tomography (CT). In a typical example application, a radiation source projects X-wavelength radiation through an object onto an electronic sensor array. By providing relative movement between one or more of the object, the source, and the sensor array, multiple views are obtained. An image of a slice through the object or a three-dimensional (“3D”) image of the object may then be approximated by use of proper mathematical transforms of the multiple views. That is, cross-sectional images of an object may be reconstructed, and in certain applications such cross-sectional images may be combined to form a full 3D image of the object.

Perhaps the best known practical application of tomography is the medical computerized tomography scanner (CT Scanner, also called computer-aided tomography or computerized axial tomography (CAT)). For instance, cross-sectional image reconstruction from radiographic (e.g., X-ray) images is commonly used in medical applications to generate a cross-sectional image (and/or 3D view) of the human body or part of the human body from X-ray images. In those applications, speed of reconstruction of the cross-sectional images has not traditionally been very important. However, as medical procedures continue to evolve, certain medical applications are beginning to desire fast reconstruction of cross-sectional images. For instance, real-time X-ray imaging is increasingly being desired by medical procedures, such as many electro-physiologic cardiac procedures, peripheral vascular procedures, percutaneous transluminal catheter angioplasty (PTCA) procedures, urological procedures, and orthopedic procedures, as examples.

Tomography is also of interest in automated inspection of industrial products. For instance, reconstruction of cross-sectional images from radiographic (e.g., X-ray) images has been utilized in quality control inspection systems for inspecting a manufactured product, such as electronic devices (e.g., printed circuit boards). That is, tomography may be used in an automated inspection system to reconstruct images of one or more planes (which may be referred to herein as “depth layers” or “cross-sections”) of an object under study in order to evaluate the quality of the object (or portion thereof). For instance, a printed circuit board (or other object under study) may comprise various depth layers of interest for inspection. As a relatively simple example, a dual-sided printed circuit board may comprise solder joints on both sides of the board. Thus, each side of the circuit board on which the solder joints are arranged may comprise a separate layer of the board. Further, the circuit board may comprise surface mounts (e.g., a ball grid array of solder) on each of its sides, thus resulting in further layers of the board that may be of interest.

The object under inspection may be imaged from various different angles of view (e.g., by exposure to X-rays at various different angles) resulting in radiographic images of the object, and such radiographic images may be processed to reconstruct an image of a layer (or “slice”) of the object. That is, X-rays may be applied from an X-ray source to an object under inspection at various different angles of view, and detectors arranged on the side of the object opposite the X-ray source may receive the X-rays and measure the X-ray transmissiveness of the object.

In certain tomographic systems, one-dimensional (“1D”) X-ray image data is captured by a radiographic imaging system, and such 1D image data is processed to construct 2D image data therefrom. A “fan-beam” imaging technique is commonly used for capturing 1D image data by the radiographic imaging system, and the captured 1D image data is typically processed using the well-known Radon theorem for constructing 2D image data. That is, a “fan-beam” geometry is commonly used by a radiographic imaging device in 2D imaging techniques for capturing 1D image data from an object under inspection. Fan-beam configurations are well-known in the art of tomography and therefore are described only briefly herein. With a fan-beam geometry, X-ray beams are projected from a single point along a single plane. To envision a fan-beam geometry, consider a point in space from which X-ray photons radiate in all directions (i.e., a source point), but only a single plane of the X-ray beams are used for imaging an object under inspection. For instance, a collimator grid may be arranged to shield all beams from the object under inspection except ones that pass through a slit in the grid, thus forming a “fan” of beams from the source point along one plane that is used for imaging the object. Thus, the fan of beams pass through the object and are captured by a line array of sensors (e.g., charged-couple devices CCDs). The fan-beam technology was commonly used for acquiring 2D cross-sectional images of a 3D body under inspection.

More recently, tomographic systems have been developed that enable 2D X-ray image data (e.g., “pixels”) to be captured by a radiographic imaging system, and such 2D image data is processed using mathematical techniques to reconstruct 3D image data therefrom. A “cone-beam” imaging technique is commonly used for capturing 2D image data by the radiographic imaging system, and the captured 2D image data is typically processed using the well-known Filtered Back Projection technique for constructing 3D image data (e.g., cross-sections of the object being imaged) from the captured 2D image data. That is, cone-beam tomography is well-known in the art and is commonly used by a radiographic imaging device in 3D tomographic techniques. In general, with the cone-beam tomography approach, an X-ray source having a cone-shaped, 3D ray output is positioned on one side of an object under inspection, a 2D array of sensors are positioned on the opposite side of the object, and the source/array are synchronously moved relative to the object. There are many suitable scan paths. For example, the source may be moved in orthogonal circles around the object under inspection, or the source may be moved along a helical path or other path along a cylinder surrounding the object. Such cone-beam tomography is preferable in many cases for reconstructing cross-sectional images, and is potentially preferable for industrial inspection systems (e.g., for electronic assembly analysis) because of the resulting image quality.

With the cone-beam technology, the X-ray images are not a 1D line array of images (e.g., CCD line array), as in the fan-beam technology. Instead, cone-beam technology results in a plane of images. Some kind of rectangular sensor array is typically used, which capture a set of pixels allocated on a plane instead of along a single line. Before the cone-beam technology, imaging techniques, such as the fan-beam technology, acquired only 1D projections. With the cone-beam technology, 2D images are captured. The 2D images that are captured are comparable to those captured by digital cameras, wherein a matrix of pixels are acquired for an object being imaged. The captured 2D images may then be processed to combine them (e.g., using the Filtered Back Projection technique) to reconstruct the 3D object under inspection (or portion thereof).

3D computed tomography techniques, such as cone-beam tomography, typically require many 2D image projections (at many different angles of view), and are typically computationally intensive for reconstructing 3D images from the 2D image data. Accordingly, an undesirably large amount of data storage capacity may be required in a 3D tomography system for storing the large amount of 2D image data acquired, and the efficiency of processing the 2D image data for reconstructing the 3D image data becomes a concern.

Within X-ray absorption tomography, a number of imaging techniques are applicable to reconstruction of cross-sectional slices. A relatively early imaging technique that was developed is known as laminography. In laminography, the X-ray source and sensor are moved in a coordinated fashion relative to the object to be viewed so that portions of an object outside a selected focal plane lead to a blurred image at the sensor (see, for example, U.S. Pat. No. 4,926,452). Focal plane images are reconstructed in an analog averaging process. An example of a laminography system that may be utilized for electronics inspection is described further in U.S. Pat. No. 6,201,850 entitled “ENHANCED THICKNESS CALIBRATION AND SHADING CORRECTION FOR AUTOMATIC X-RAY INSPECTION.”

A major disadvantage of the laminography technique is that each imaging iteration provides only one cross-section of the object under inspection at a specific height. For example, when inspecting a printed circuit board, a cross-section which is parallel to the printed circuit board and which crosses all joints on the top of the board rather than on the bottom of the board may be desired for inspection of the quality of the solder joints on the board. Current laminographic techniques create one cross-section of a board under inspection at a specific height at a time. Thereafter, the board may be sequentially imaged again and again at different heights. With each imaging iteration, a picture is obtained of a cross-section at a particular height. For instance, in the 5DX inspection system manufactured by Agilent Technologies, a single imaging iteration comprises a full circle rotation of the scintilator coupled with the full rotation of the electron beam in the X-ray tube. During that rotation, the charges induced by the photons absorbed on the CCD matrix of the imager form an (analog) image representing just one horizontal slice in the object under inspection (along the object under inspection, such as a circuit board). The image is read from the CCD and is transformed into digital form for further processing by an analog-to-digital converter. In view of the above, much time is spent acquiring the needed images for inspecting an object using traditional laminographic techniques. Accordingly, laminography is generally unsuitable for many high-speed imaging applications, such as in an industrial inspection device (e.g., for inspecting printed circuit boards or other objects) on a high-speed production line.

A second disadvantage of the laminographic technique is that the technique itself is not able to remove shadows that are caused by other parts. It provides some cross-section of the object under inspection, but it is not very clear compared with what can be obtained with more recent tomographic techniques.

The next imaging technique developed was tomosynthesis. Tomosynthesis is an approximation to laminography in which multiple projections (or views) are acquired and combined. As the number of views becomes large, the resulting combined image generally becomes identical to that obtained using laminography with the same geometry. A differentiating feature of tomosynthesis from the above-described laminographic technique is that in tomosynthesis X-ray images obtained from different directions (different angles of view) can be combined (e.g., overlapped with different spatial shifts and their brightness summed) producing a variety of cross-sections. In other words, one set of X-ray images can be used to obtain multiple cross-sections of an object under inspection (e.g., cross-sections of the object at different heights). Tomosynthesis may be performed as an analog method, for example, by superimposing sheets of exposed film. Tomosynthesis may, instead, be performed as a digital method. In digital tomosynthesis, the individual views are divided into pixels, and digitized and combined via computer software.

Various mathematical techniques have been proposed for combining the acquired X-ray images. For example, a so called shift-and-add method or a simple Back Projection (with no filtering) technique may be used for combining the acquired X-ray images in tomosynthesis. The shift-and-add technique is simpler in calculation but results in different scales in the calculated cross-sections (at different heights). The Back Projection technique assumes that one follows (imaginary) lines (or “beams”) from the pixels of the X-ray image toward the X-ray spot (along the passes the X-ray photons were traveling), and fills all voxels in the space grid with the brightness of the pixel the pass originated from. If passes from different pixels intersect at a voxel, then the brightness of the voxel is the sum of the brightness of contributing pixels.

Such simple Back Projection techniques (with no filtering) are well known in the art. Simple Back Projection techniques do not involve a solution of equations, and works with arbitrary positioning of sources and images in a radiographic imaging system. That is, simple Back Projection techniques may be utilized for processing 2D image data (pixels) captured by a radiographic imaging system having an irregular geometry and enables processing of the pixels in an arbitrary order. However, the resulting image of 3D volume produced by such simple Back Projection techniques suffers in quality in that it contains shadows from all objects along the passes.

The next step in the development of the calculations for tomographic techniques (i.e., for combining the acquired X-ray images to construct a cross-sectional image) was the so-called Filtered Back Projection (FBP) method. FBP techniques are well known in the art of image processing. FBP techniques provide improvement in quality but some decrease in speed over the simple Back Projection techniques. FBP involves some mathematics utilizing the regular spacing of the X-ray sources and imagers to get an explicit solution of equations. Thus, FBP techniques are dependent on (or require) a regular geometry in the radiographic imaging system such that 2D pixels are captured for processing by the FBP in a very regular, pre-defined order.

Automated inspection systems that provide reconstruction of cross-sectional images of an object under inspection from radiographic (e.g., X-ray) images captured for such object have been unable to provide quality analysis quickly enough to keep up with most production lines. Because of cost, speed, and/or the mechanics required to obtain multiple radiographic images (e.g., images at various different angles), many of the traditional approaches to tomography (such as those traditionally used for medical applications that do not require fast reconstruction) are not suitable for a manufacturing environment. For example, a printed circuit board assembly line generally moves very fast. For instance, printed circuit boards may be spaced merely seconds apart on a production line, and therefore, to implement an automated X-ray inspection system in a production setting, such inspection system needs to be very fast. Ideally, the inspection process is in real time, as part of a feedback control system for the manufacturing process. In many manufacturing environments there is a need to verify the integrity of tens of thousands of solder joints within one minute or less. Typically, automated X-ray inspection systems severely limit the speed at which a production line may operate, and thus automated X-ray inspection systems are generally preserved for use in inspecting relatively specialized, high-cost boards that are typically manufactured in relatively low quantities, wherein speed of the manufacturing line is not so important. Of course, automated X-ray inspection systems would likely be used more often if they could operate fast enough to keep up with high throughput production lines.

### BRIEF SUMMARY OF THE INVENTION

The present invention is directed to a tomographic system and method which enable iterative processing of 2D image data for reconstructing 3D image data therefrom. For example, in certain embodiments, a conjugate gradient algorithm is utilized to iteratively process captured 2D image data (e.g., pixels) for reconstructing 3D image data (e.g., voxels) therefrom.

In accordance with one embodiment of the present invention, a method for processing 2D image data for reconstructing 3D image data therefrom is provided. The method comprises receiving a plurality of 2D images acquired at different angles of view, and iteratively processing the received 2D images to reconstruct 3D image data therefrom. As described further herein, such iterative processing may, for example, use a conjugate gradient algorithm for reconstructing the 3D image data.

In accordance with another embodiment of the present invention, a system for processing 2D image data for reconstructing 3D image data therefrom is provided. The system comprises a means for receiving a plurality of 2D images acquired at different angles of view, and a means for iteratively processing the received 2D images to reconstruct 3D image data therefrom. Again, in certain implementations, the means for iteratively processing may implement a conjugate gradient algorithm.

In accordance with another embodiment of the present invention, a system for processing 2D image data for reconstructing 3D image data therefrom is provided. The system comprises an imaging system operable to capture a plurality of 2D images at different angles of view. The system further comprises a reconstruction processor communicatively coupled to the imaging system. The reconstruction processor is operable to receive the plurality of captured 2D images and iteratively process the received 2D images to reconstruct 3D image data therefrom in accordance with a conjugate gradient algorithm.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a schematic representation of an example 3D tomography system geometry which may be used with embodiments of the present invention for capturing 2D radiographic images that may be processed for reconstructing 3D images in accordance with embodiments of the present invention;

FIG. 2A shows a cubical object that has been divided into 125 (5×5×5) identically sized cubic voxels;

FIG. 2B shows two layers of voxels for the object of FIG. 2A;

FIG. 2C shows an example radiographic imaging system that may be used for capturing 2D radiographic images of an object, which may be processed for reconstructing 3D images in accordance with embodiments of the present invention;

FIGS. 3A-3D show example cross-sectional images that may be produced by a 3D reconstruction process for a sample object;

FIG. 4 shows an example printed circuit board assembly that may be inspected in accordance with embodiments of the present invention;

FIGS. 5A-5D show an example test scene that includes basic geometrical primitives, wherein such example test scene may be imaged by a 3D tomographic system;

FIG. 6 shows an example dialog describing the exact locations, sizes, and ranks assigned to the geometrical primitives of the example test scene of FIGS. 5A-5D;

FIG. 7 shows 2D slices combined into a tile that represents a 3D volume of the example test scene of FIGS. 5A-5D;

FIGS. 8A-8B show 2D radiographic images of the example test scene of FIGS. 5A-5D from which 3D image data may be reconstructed in accordance with embodiments of the present invention;

FIG. 9 shows an example graph illustrating the progress of the Conjugate Gradient (CG) algorithm after each step of iteration in processing the example test scene of FIGS. 5A-5D;

FIG. 10 shows an example graph illustrating the observed migration of the solution into non-physical (negative) cross-sections when the CG algorithm is used for processing the example test scene of FIGS. 5A-5D;

FIG. 11 shows a graph that illustrates an example L-curve that is associated with the 3D tomographic reconstruction when the CG algorithm is used for processing the example test scene of FIGS. 5A-5D;

FIG. 12A shows a tile that comprises 32 slices resulting from a traditional tomosynthesis technique for 3D tomographic reconstruction of the example test scene of FIGS. 5A-5D;

FIG. 12B shows a tile that comprises the 32 slices of FIG. 12A with log brightness normalization having been applied thereto;

FIG. 13A shows a tile that comprises 32 slices resulting from an example CG processing method of an embodiment of the present invention for 3D tomographic reconstruction of the example test scene of FIGS. 5A-5D;

FIG. 13B shows a tile that comprises the 32 slices of FIG. 13A with log brightness normalization having been applied thereto;

FIG. 14 shows an example high-level block diagram for a system implementing a 3D image reconstruction process of an embodiment of the present invention; and

FIG. 15 shows an example graph of points in 3D space for which a Laplacian operator acting on these points and centered at the point 1 may be computed.

### DETAILED DESCRIPTION OF THE INVENTION

In view of the above, tomographic reconstruction has a long history of development and a lot of applications in many areas, like health monitoring, industrial vision, nondestructive inspection, airport security, etc. It is often desirable to provide a 3D tomographic technique that maintains high quality 3D reconstruction on one hand, and that provides high throughput of the 3D reconstruction on the other hand. In general, these two desires contradict each other because achieving high quality reconstruction has traditionally required acquiring a large number of 2D X-ray images and performing significant computational processing of the 2D images (thus reducing the throughput of the 3D reconstructions). As a result, the majority of practically used algorithms in such well established applications as medical diagnostics and security inspection require many minutes to complete the gathering of 2D X-ray images and processing the 2D images to reconstruct 3D images therefrom by using such widely known methods as FBP and Fourier methods.

As an example of the current state of the art for 3D tomography, the 5DX inspection system manufactured by Agilent Technologies is commonly used by the electronic industry for the fast X-ray inspection of printed circuit boards on conveyer belts of production lines. The 5DX inspection system is not capable of utilizing existing tomographic algorithms because of the required high throughput of the system (e.g., because of the relatively high-speed production lines on which it is typically implemented). So, the 5DX system operates utilizing an analog-based technique in which object volume reconstruction is performed by the laminographic method based on fixed polar angle azimuth-rotational cone-beam geometry. As a result, reconstructed images of volume layers suffer from substantial shadows from other overlapping layers and have low resolution in the direction perpendicular to the surface of the printed circuit boards under inspection. Another disadvantage resulting from the use of the laminographic technique, is that it is capable of reconstructing only one 3D cross-section at a time, and obtaining additional cross-sections (through increasing the number of imaging iterations) reduces the throughput of the system.

As described above, tomographic techniques exist for capturing 2D image data for an object under inspection and processing the 2D image data to reconstruct 3D image data therefrom. For example, a radiographic imaging device may implement the well-known cone-beam technique for capturing 2D image data for an object under inspection, and the 2D image data may be processed using a mathematical technique, such as FBP, to reconstruct 3D image data therefrom. However, the FBP techniques commonly used for reconstructing the 3D image data in such 3D tomographic systems generally require adherence to a predefined, rigid order of acquiring the 2D image data. For instance, the mathematics used in FBP require that the directions from which the 2D image data is acquired (i.e., the various different angles of view) be very orderly assigned. More specifically, a constant step in the angle of view used for acquiring the 2D image data is generally required. There are many different methods for implementing FBP, but all of the methods require a very regular geometry for implementing the X-ray source and sensor array.

For example, a radiographic imaging device may be implemented that comprises an X-ray source and a sensor array that are positionally fixed, and an object to be inspected is rotated/translated between the source and sensor array such that 2D images of the object can be acquired at various different angles of view. An image reconstruction processor may receive the 2D image data and may implement a traditional FBP technique for reconstructing 3D image data from the 2D image data. Such traditional FBP techniques generally require that the object under inspection be rotated according to very regularly defined, equal steps of rotation, such that 2D images are acquired at very ordered, constant steps of different angles of view. For instance, a FBP technique may require that the body be rotated for imaging at 500 different angles of view that are equally spaced. So, for example, an object under inspection may be required to be rotated to a first position and then imaged (i.e., capture 2D image data at that position), then be rotated by one degree to another angle of view and again imaged, and then be rotated by one more degree to a next angle of view and again imaged, and so on. Each time the object is rotated, it may be translated along a Z-axis (so as to change the relative distance between it and the X-ray source). In such configuration, the distance that the object is translated along the Z-axis is typically required to be relatively constant for each translation. Accordingly, the acquisition of 2D images is required by FBP processing techniques to be performed according to a very regular order.

Having such a stringent requirement that the 2D images be acquired in such a regularly ordered way is disadvantageous for certain applications. For instance, in certain applications it may be desirable to acquire 2D image data for an object under inspection at angles of view that are not necessarily regularly ordered, and process the 2D image data for reconstructing 3D image data. For instance, it may be desirable to rotate an object under inspection to a first position for imaging (acquisition of 2D image data at this first angle of view), then rotate the object by one degree for imaging at a new angle of view, and then rotate the object by another 20 degrees for imaging at another angle of view. Accordingly, it may be desired that the acquisition of the 2D image data not be performed according to a regular order.

3D tomographic techniques that require 2D image data to be acquired according to a regular order, such as FBP techniques, present a big obstacle for their use in certain applications, such as the inspection of printed circuit boards for example. A printed circuit board is generally a very planar structure. Typically, the length and width of a printed circuit board is much greater than its thickness. For instance, the length and width of a printed circuit board are commonly so great that X-ray imaging of the printed circuit board along its length and width is fruitless. That is, X-ray beams may be unable to penetrate along the board's length and width because of the large number of different parts that may be installed on the board. Thus, the useful 2D image data is acquired by imaging through the thickness of the printed circuit board. Thus, imaging of a printed circuit board in all directions is not efficient, as image data suitable for processing is not acquired when it is imaged along its length and width. However, with traditional 3D tomographic techniques, such as those using FBP, a prescribed number of 2D images at different angles of view must be acquired in a very regular order for reconstructing the 3D image data. Thus, being unable to acquire the 2D image data along certain angles of view (e.g., along the width and/or length of a printed circuit board) substantially effects the resulting reconstructed 3D image in these traditional 3D tomographic techniques.

Another disadvantage of traditional 3D tomographic techniques, such as those using FBP, is that they generally require a large amount of 2D image data to be acquired for processing. For instance, a traditional tomographic technique using FBP for performing 3D reconstruction may require about 500 different 2D X-ray images to be acquired, each from a different angle of view. Such a large number of 2D images is undesirably costly in terms of data storage requirements and/or processing costs for many applications. That is, storage of such a large number of 2D images may consume too much data storage (e.g., memory), and/or processing such a large number of 2D images may be too computationally intensive (e.g., may take too long) to be acceptable for many applications.

In view of the above, a desire exists for a 3D tomographic technique that does not require acquisition of 2D image data in accordance with a regular order. Further, a desire exists for a 3D tomographic technique that does not require such a large number of 2D radiographic (e.g., X-ray) image projections to be acquired for reconstructing the 3D images.

Embodiments of the present invention provide an iterative tomographic technique for reconstructing 3D images from 2D image data. Preferably, the 3D images are reconstructed through iterative processing of the 2D image data using, for example, a conjugate gradient algorithm. Further, certain embodiments of the present invention provide a technique that allows 2D images to be acquired from arbitrary different angles of view, and it allows the acquired 2D images to be used for reconstructing a 3D image through the iterative processing. That is, certain embodiments of the present invention do not require that the 2D radiographic (e.g., X-ray) images be acquired in accordance with a predefined, regular order. Certain embodiments of the present invention implement an iterative technique for solving linear equations for enabling reconstructing of 3D image data from 2D radiographic images that may be acquired at different angles of view, wherein the technique is not restricted to a specific order of acquiring the different angles of view.

Accordingly, embodiments of the present invention provide a new class of 3D tomographic methods that are able to significantly reduce the computational time for many applications, such as the above-mentioned tomographic inspection of printed circuit boards. That is, because a 3D tomographic technique is provided that is not dependent on regularly ordered 2D image data, the acquisition of 2D image data may be performed in an irregular manner that minimizes the amount of such 2D image data that is captured and processed for a given application. For instance, in a given application, such as inspection of printed circuit boards, much fewer angles of view than are traditionally required for FBP techniques may be used for acquiring 2D images that are processed for 3D reconstruction. Thus, a plurality of 2D radiographic images may be acquired for an object under inspection (e.g., a printed circuit board) each at a different angle of view, wherein the various angles of view need not be regularly ordered, and embodiments of the present invention are operable to process the acquired 2D radiographic images for reconstructing 3D image data for the object under inspection.

Embodiments of the present invention may be implemented to enable reconstruction of 3D image data for a broad class of geometrical allocations of a point-like X-ray source and X-ray sensors that may be implemented in a tomographic system. For instance, an optimal geometrical configuration of a radiographic imaging system may be implemented for imaging a particular type of object (e.g., a printed circuit board), and embodiments of the present invention may be implemented to enable reconstruction of 3D image data through iterative processing of 2D image data captured by the optimally configures radiographic imaging system. Thus, the processing technique of embodiments of the present invention eliminates the existing constraints on the possible image acquisition geometries of tomographic machines.

Further, the mathematical structure used by embodiments of the present invention for processing the 2D image data allows effective utilization of the reconstruction technique via parallel computation, and as a result, the computational time may be reduced by, for example, several times compared with the current state of the art 3D tomographic algorithms. Embodiments of the present invention may be utilized within various types of 3D tomographic systems. That is, embodiments of the present invention may be utilized for processing 2D image data to reconstruct 3D image data therefrom, wherein any suitable radiographic imaging device may be employed for capturing the 2D image data, including without limitation well-known parallel beam or cone-beam geometries. No additional overhaul of the algorithm for processing the 2D image data (and its corresponding hardware/software implementation) is required to be utilized with a specific geometry of a system. Rather, in certain embodiments, a simple reprogramming of an address look-up table for the reconstruction algorithm enables the algorithm to be readily adapted a new tomographic system geometry.

According to embodiments of the present invention, which are described further below, 2D radiographic images (e.g., X-ray images) of an object under inspection may be captured by a radiographic imaging system, and such 2D radiographic images are processed to reconstruct 3D image data (e.g., cross-sectional images) of the object. Preferably, a digital-based radiographic imaging system, such as a cone-beam tomography imaging system, is used to capture the 2D radiographic images of an object under inspection, wherein such digital-based radiographic imaging system outputs the 2D image data in digital form (i.e., as “pixels”). In embodiments of the present invention, the captured 2D radiographic images of an object may be input to an image reconstruction processor to reconstruct, from such 2D radiographic images, 3D image data for the object under inspection. As described in greater detail below, such image reconstruction processor implements an iterative processing technique, such as a conjugate gradient algorithm, for processing the 2D images to construct the 3D images therefrom.

As described above, tomographic image processing of objects, such as solder joints on a printed circuit board, is utilized in automated inspection systems for quality control. For example, a solder joint on a printed circuit board may be imaged (e.g., by a radiographic imaging system), and such image may be processed by an automated inspection system to determine various parameters, such as length, width, curvature, relative opacity, and similar values of the solder joint. The various parameters determined for the solder joint may then be evaluated by the automated inspection system (or by a human inspector) to determine whether the solder joint is of acceptable quality.

As an example, the thickness of solder material (which is typically a combination of lead and tin) may be inspected by an automated inspection system through analysis of X-ray image(s) of the solder material. In an X-ray image of solder material, there is a relationship between the intensities comprising the X-ray image and the thicknesses of the solder material forming the X-ray image. Typically, the image intensity increases from values corresponding to lighter shades of gray (white) to values corresponding to darker shades of gray (black) as the thickness of the solder material increases. That is, the image of a thin section of solder will have a gray level that is less than the gray level of the image of a thicker section of solder. The image of the thin section will appear to be a lighter shade of gray than the image of the thicker section. This convention is typically used in electronic image representation of X-ray images, however, the opposite convention may also be used, i.e., where the image of a thin section of solder has a gray level that is greater than the gray level of the image of a thicker section of solder. The latter convention has traditionally been followed in film radiography where the X-ray images are recorded on X-ray film. Either convention may be implemented with embodiments of the present invention.

Embodiments of the present invention are preferably implemented in a 3D digital tomography system. Various 3D digital tomography imaging systems are well-known in the art, any of which may be used in conjunction with embodiments of the present invention, and thus example imaging systems are only briefly described herein so as not to detract attention away from the inventive system and method for reconstructing 3D image data for an object under inspection. Example 3D tomography systems that have been proposed for use in industrial inspection systems and in which embodiments of the present invention may be implemented include those disclosed in U.S. Pat. No. 6,002,739 entitled “COMPUTED TOMOGRAPHY WITH ITERATIVE RECONSTRUCTION OF THIN CROSS-SECTIONAL PLANES” and U.S. Pat. No. 6,178,223 entitled “IMAGE RECONSTRUCTION METHOD AND APPARATUS,” the disclosures of which are hereby incorporated herein by reference in their entirety. Of course, various other digital 3D tomography system configurations now known or later developed may be used, and embodiments of the present invention may be implemented with such systems to improve the efficiency of the 3D reconstruction process thereof. Embodiments of the present invention may be utilized in conjunction with any radiographic imaging device that is capable of capturing 2D image data of an object under inspection. More specifically, as described further below, embodiments of the present invention may be utilized in conjunction with such a 2D radiographic imaging device for efficiently reconstructing 3D image data for the object under inspection from the captured 2D image data.

FIG. 1 shows a schematic representation of an example 3D digital tomography system geometry which may be used with embodiments of the present invention. More specifically, FIG. 1 shows an example cone-beam tomography system. An X-ray source 20 emits X-rays 25 in a cone-shaped pattern. The X-rays pass through an object 10 (e.g., a circuit board) to be imaged. The X-rays are sensed by an array of sensors 30. To obtain multiple views, X-ray source 20 may travel in a circular path as illustrated, with sensors 30 traveling in a coordinated circular path. Note that X-rays 25 may be generated by bombarding the surface of an X-ray tube with an electron beam. By electronically deflecting the electron beam, the X-ray source is effectively moved. Thus, the X-ray source 20 and/or sensors 30 may not actually move (but may instead be positionally-fixed) and instead the effect of their movement may be achieved through other techniques, such as by deflecting the X-ray source (e.g., to achieve imaging of the object 10 at various different angles of view).

While an example circular path of source 20 and sensors 30 is shown in FIG. 1, it should be understood that many other suitable scan paths exist for obtaining multiple radiographic images that may be used for reconstructing cross-sectional images of object 10, and embodiments of the present invention are not limited to any particular scan path. In general, for a complete 3D reconstruction of an object, the scan path needs to surround the object. The path illustrated in FIG. 1 is not capable of providing data for an exact, mathematically complete, 3D reconstruction of an arbitrary object 10. However, it provides sufficient data for practical application given the depth layers (or “planes”) of the object that are of interest to be reconstructed. In addition, the scan path illustrated in FIG. 1 is convenient for scanning large, nearly planar, objects. Large planar objects (e.g., typical circuit boards) may be translated in two dimensions to provide imaging of different parts of the objects, without requiring the source and sensor to be moved completely around its large volume.

Of course, various other configurations of a digital radiographic imaging system operable to capture digital, 2D radiographic images of an object 10 may be implemented with embodiments of the present invention, including without limitation that disclosed in U.S. Pat. No. 6,178,223. While a cone-beam radiographic imaging system, such as that of FIG. 1, is used in conjunction with a preferred embodiment of the present invention, it should be recognized that the present invention is not limited to a specific configuration of a digital radiographic imaging system. Rather, any configuration of a digital radiographic imaging system operable to capture digital, 2D radiographic images of an object 10 that are now known or later developed may be implemented with embodiments of the present invention. That is, various configurations now known or later developed for capturing digital, 2D radiographic images of an object 10 may be used in conjunction with the image reconstruction process described hereafter for efficiently reconstructing, from the 2D radiographic images, 3D image data (e.g., cross-sectional images) of object 10.

Conventional 3D digital tomography approximates an object by discrete volume elements, called voxels. “Voxels” (or “volume pixels”) are well known in the art of image processing, and are commonly used in 3D imaging. In general, a voxel is the smallest distinguishable box-shaped part of a three-dimensional image. “Voxelization” is the process of adding depth to an image using a set of cross-sectional images known as a volumetric dataset. These cross-sectional images (or slices) are made up of pixels. The space between any two pixels in one slice is referred to as interpixel distance, which represents a real-world distance. And, the distance between any two slices is referred to as interslice distance, which represents a real-world depth. The volumetric dataset is processed when slices are stacked in computer memory based on interpixel and interslice distances to accurately reflect the real-world sampled volume. Next, additional slices may be created and inserted between the dataset's actual slices so that the entire volume may be represented as one solid block of data. Once the dataset exists as a solid block of data, the pixels in each slice take on volume and thus become voxels.

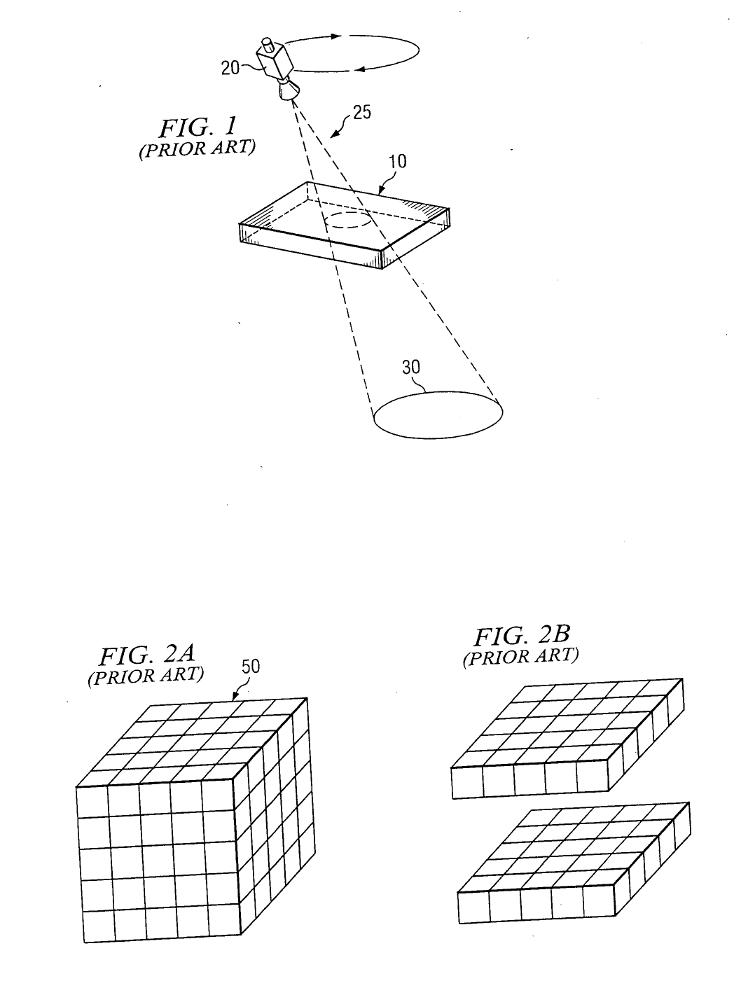

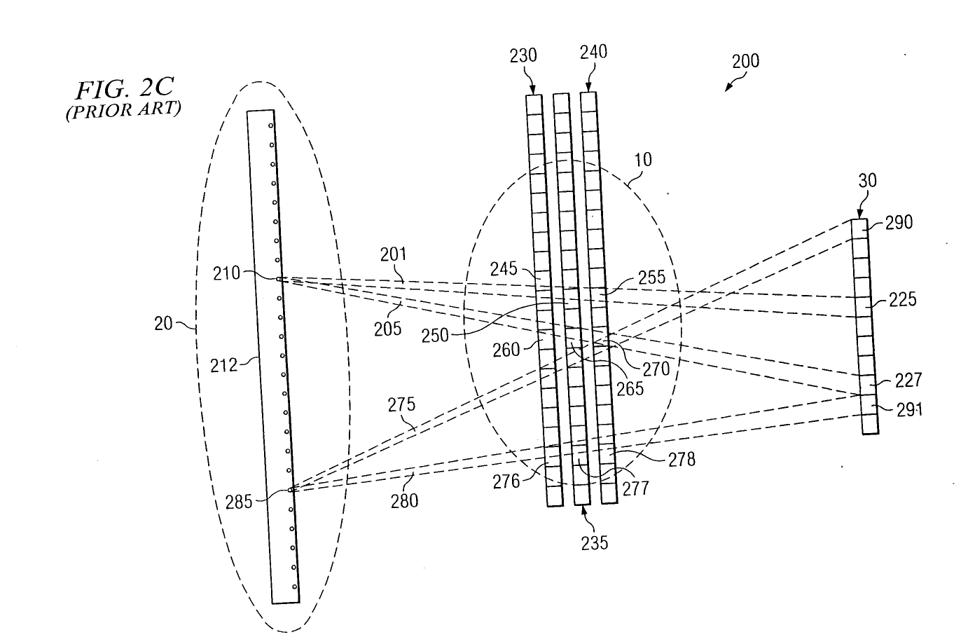

For better understanding of certain principals commonly utilized in 3D tomography and which may be utilized in certain embodiments of the present invention described herein below, aspects of conventional image processing techniques are described in conjunction with FIGS. 2A-2C. Just as embodiments of the present invention are not limited to the example radiographic imaging system configuration described in conjunction with FIG. 1, embodiments of the present invention are not intended to be limited in any way by the general image processing principals described in conjunction with FIGS. 2A-2C. Rather, image processing principals, such as use of voxels, is briefly described in conjunction with FIGS. 2A-2C to aid the understanding of the reader to the extent that such principals are described herein as being used in embodiments of the present invention.

FIG. 2A illustrates a cubical object 50 that has been divided into 125 (5×5×5) identically sized cubic voxels. For 3D imaging of object 50, the density (or absorption coefficient, or material thickness) of each of the 125 voxels is reconstructed from the data represented in multiple views (at different angles of view) of object 50 as detected by an array of sensors such as array 30 in FIG. 1.

For many applications, a complete 3D image is not necessary. For example, for inspection of a double-sided circuit board (such as that shown in FIG. 4), a few image planes or “cross-sections” (such as image planes 410 and 412 in FIG. 4) may be sufficient to determine solder joint quality. FIG. 2B shows two layers of voxels for the object 50 of FIG. 2A.

Referring to FIG. 2C, an example radiographic imaging system 200, such as that described more fully in U.S. Pat. No. 6,178,223, that may be used for capturing 2D radiographic images of object 10 is shown. In this example configuration of a radiographic imaging system, source 20 includes a collimator grid 212 that is capable of directing a plurality of X-ray beams (which may comprise a plurality of X-ray beam subpaths, as described hereafter) to object 10 at various different angles of view. While collimator grid 212 is used in the example system 200 of FIG. 2C to direct X-ray beams to object 10 at various different angles for capturing sufficient 2D image data for reconstructing various depth layers of object 10, it should be recognized that various other techniques now known or later discovered for simultaneously or serially generating X-ray beams that are directed to object 10 at various different angles of view may be used in other configurations.

As shown in this example, a first X-ray beam subpath 201 and second X-ray beam subpath 205 are ones of many X-ray beam subpaths emanating from a first aperture 210 of collimator grid 212. The remaining X-ray beam subpaths are not shown for the sake of clarity and explanation. Some of the X-rays that travel along first X-ray beam subpath 201 and second X-ray beam subpath 205 pass through object 10 and strike detectors 225 and 227, respectively, of multi-detector array 30. It will be recognized that the information provided to detector 225 by X-rays traveling along first X-ray beam subpath 201 does not correspond to any single point within object 10; rather the path of the first X-ray beam subpath 201 as it passes through the object 10 forms a volume which intersects first slice (or “cross-section” or “depth layer”) 230, second slice, 235, and third slice 240. Particularly, X-rays traveling along first X-ray beam subpath 201 creates a volume which is completely or partially coincident with first voxel 245 (of depth layer 230), second voxel 250 (of depth layer 235), and third voxel 255 (of depth layer 240).

The 2D image information obtained by detector 225 from X-ray beam subpath 201 may contribute to reconstruction of a first voxel 245 in a reconstructed cross-sectional image corresponding to depth layer 230, to reconstruction of a second voxel 250 in a reconstructed cross-sectional image corresponding to depth layer 235, and to reconstruction of a third voxel 255 in a reconstructed cross-sectional image corresponding to depth layer 240. Thus, 2D pixel data output from detector 225 of sensor 30 generally contributes to reconstruction of 3D voxels of a plurality of different cross-sections (or depth layers) of object 10. Such pixel data is received by an image reconstruction processor and processed in the manner described more fully herein below to reconstruct the plurality of different cross-sections.

With respect to second X-ray beam subpath 205, the 2D information provided by detector 227 may contribute to reconstruction of a fourth voxel 260 in a reconstructed cross-sectional image corresponding to depth layer 230, to reconstruction of a fifth voxel 465 in a reconstructed cross-sectional image corresponding to depth layer 235, and to reconstruction of a sixth voxel 270 in a reconstructed cross-sectional image corresponding to depth layer 240.

A third X-ray beam subpath 275 and fourth X-ray beam subpath 280 are two of many X-ray beam subpaths emanating from a second aperture 285. The remaining X-ray beam subpaths emanating from second aperture 285 are not shown for the sake of clarity and explanation. Some of the X-rays that travel along X-ray beam subpath 275 and X-ray beam subpath 280 pass through object 10 and strike detectors 290 and 291, respectively. As described above with subpaths 201 and 205, the intensity information provided to detector 290 by X-rays traveling along third X-ray beam subpath 275 does not correspond to any single point within object 10; rather the intensity information is an aggregation of information for a volume that intersects all plane/slices between collimator grid 212 of source 20 and multi-detector array 30, including the plane/slices containing voxel 270. Likewise, the intensity information provided to detector 291 by X-rays traveling along fourth X-ray beam subpath 280 does not correspond to any single point within object 10; rather the intensity information is an aggregation of information for a volume that intersects all plane/slices between collimator grid 212 of source 20 and multi-detector array 30, including the plane/slices containing voxels 276, 277, and 278.

Pixel data corresponding to the intensity detected by sensor 30 is preferably output by radiographic imaging system 200 to an image reconstruction processor, such as that described more fully below. In certain embodiments, the image reconstruction processor processes the received pixel data by, for example, combining or summing the intensity for a voxel from all of the detectors that detect X-rays traveling along X-ray beam subpaths that are completely or partially coincident with that particular voxel and have been assigned to that voxel for the purpose of reconstruction. For example, intensity data collected by detector 227 from X-ray beam subpath 205 in a first pixel output thereby and intensity data collected by detector 290 from X-ray beam subpath 275 in a second pixel output thereby may be used in reconstructing sixth voxel 270 (as both X-ray beam subpaths 205 and 275 intersect with sixth voxel 270). As described further below, an iterative technique, such as a conjugate gradient method, may be implemented in embodiments of the present invention for processing the 2D pixel data for reconstructing the 3D voxel data.

The radiographic imaging geometry and apparatus shown and described with reference to FIGS. 1 and 2C are typical of that which may be used in conjunction with embodiments of the present invention. However, specific details of these systems are not critical to the practice of the present invention, which addresses processing of 2D image data for reconstruction of 3D image data (e.g., cross-sectional images). For example, the specific details of the X-ray source, detector, positioning mechanism(s) for positioning the object under inspection, control system (e.g., computer) for controlling the operation of the imaging system, etc. may vary considerably from system to system. Embodiments of the present invention are applicable to any type of system which acquires 2D digital radiographic images of multiple depth layers of an object (e.g., circuit board) and uses such 2D digital radiographic images to reconstruct 3D (cross-sectional) images corresponding to the multiple depth layers of the object.

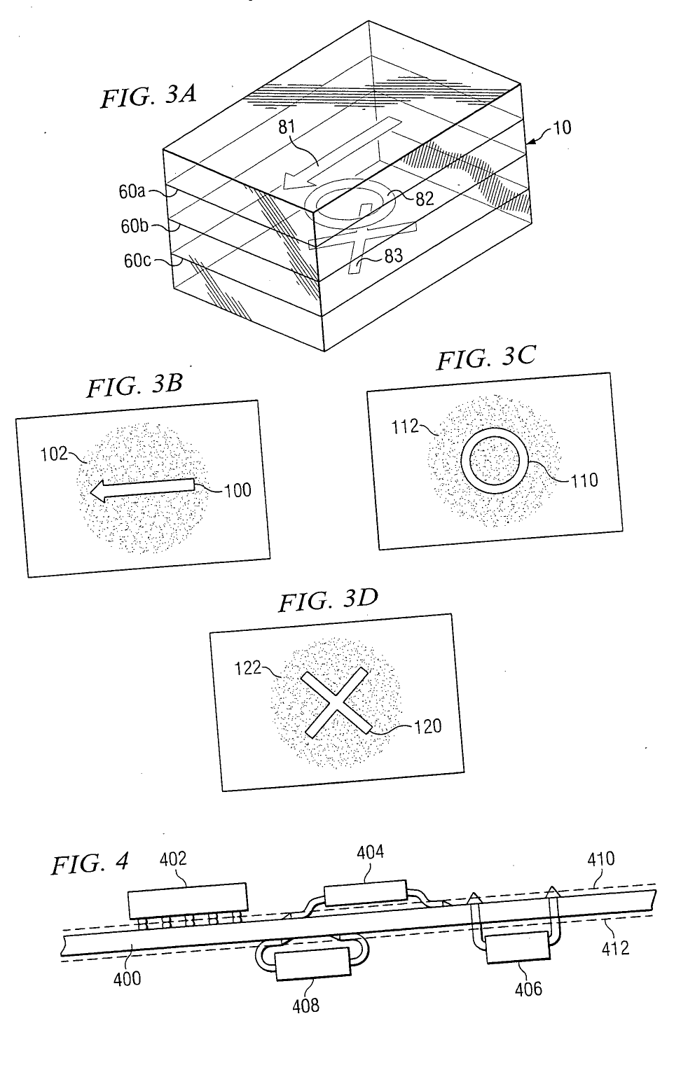

FIGS. 3A-3D show example cross-sectional images that may be produced by a reconstruction process for a sample object 10. For illustrative purposes, object 10 shown in FIG. 3A has test patterns in the shape of an arrow 81, a circle 82, and a cross 83 embedded within the object 10 in three different planes (or depth layers) 60a, 60b and 60c, respectively.

FIG. 3B shows a sample cross-sectional image (or “tomograph”) of depth layer 60a of object 10 that may be reconstructed by an image reconstruction processor, which may implement the image reconstruction technique of embodiments of the present invention described below. The image 100 of arrow 81 is in sharp focus, while the images of other features within the object 10, such as the circle 82 and cross 83 may form a blurred region 102 which does not greatly obscure the arrow image 100. Preferably, blurred region 102 and/or its effects on the arrow image 100 is minimized in the reconstruction process to provide a high-quality image of the cross-section as described with embodiments of the present invention below.

Similarly, FIG. 3C shows a sample cross-sectional image (or “tomograph”) of depth layer 60b of object 10 that may be reconstructed by an image reconstruction processor. The image 110 of circle 82 is in sharp focus, while the images of other features within the object 10, such as the arrow 81 and cross 83 may form a blurred region 112 which does not greatly obscure the circle image 110. Again, preferably blurred region 112 and/or its effects on the circle image 110 is minimized in the reconstruction process to provide a high-quality image of the cross-section as described with embodiments of the present invention below.

FIG. 3D shows a sample cross-sectional image (or “tomograph”) of depth layer 60c of object 10 that may be reconstructed by an image reconstruction processor. The image 120 of cross 83 is in sharp focus, while the images of other features within the object 10, such as the arrow 81 and circle 82 may form a blurred region 122 which does not greatly obscure the cross image 120. Again, preferably blurred region 122 and/or its effects on the cross image 120 is minimized in the reconstruction process to provide a high-quality image of the cross-section as described with embodiments of the present invention below.

While FIGS. 3A-3D show an example object 10 having depth layers 60a, 60b, and 60c that may be reconstructed as cross-sectional images, it should be recognized that object 10 is intended as a generic example to illustrate the concept of reconstructing various depth layers of an object as cross-sectional images. In practice, various other types of objects having any number of depth layers may be inspected, and any number of their depth layers may be reconstructed as cross-sectional images. For example, a preferred embodiment may be implemented with an automated inspection system for inspecting solder joints on a printed circuit board. FIG. 4 depicts an example printed circuit board assembly that may have various depth layers thereof reconstructed as cross-sectional images by an image reconstruction processor of a preferred embodiment of the present invention in order to inspect the printed circuit board assembly.

Thus, FIG. 4 provides a concrete example of an object that may be inspected in accordance with embodiments of the present invention. Of course, embodiments of the present invention are not intended to be limited solely in application to reconstructing 3D images of a circuit board, but may instead be utilized in many other applications in which reconstruction of 3D images from captured 2D radiographic image data is desired, including without limitation inspection of various other types of products in a manufacturing environment for quality control, use in automated inspection systems for inspecting objects for contraband contained therein (e.g., security systems for inspecting passenger luggage at an airport or other transportation facility), and/or use in various medical applications. Various other applications of the image reconstruction process of embodiments of the present invention will be recognized by those of ordinary skill in the art.

In FIG. 4, a double-sided printed circuit board 400 has multiple components soldered to each of two exterior surfaces. Components 402 and 404 are mounted onto a first surface. Component 408 is mounted onto a second surface that is opposite the first surface. Component 406 is a through-hole component mounted onto the second surface, but with leads that pass through both surfaces of board 400. Typically, the electrical connections coupling components 402, 404, 406, and 408 to board 400 are formed of solder. However, various other techniques for making the electrical connections are well known in the art and even though example embodiments of the present invention will be described herein in terms of solder joints, it should be understood that other types of electrical connections, including but not limited to conductive epoxy, mechanical, tungsten and eutectic bonds, may be inspected utilizing embodiments of the invention.

In this example, component 402 has a ball-grid array (BGA) of solder joints. Component 404 illustrates a gull-wing surface mount device. Component 408 is a J-lead surface mount device. One plane (or depth layer), depicted dashed line 410, just off the first surface of circuit board 400 passes through the leads and solder fillets of components 402, 404, and 406. Another plane (or depth layer), depicted by dashed line 412, just off the second surface of circuit board 400 passes through the leads and solder fillets of components 406 and 408. It should be understood that while two example depth layers (410 and 412) are specified in this example, in other examples any number of depth layers of circuit board 400 may be examined. Further, while various types of solder joints (e.g., surface mounts and in-board joints) are shown in this example as being included within a common depth layer, such as the various joints of components 402, 404, and 406 falling within depth layer 410, it should be understood that in some implementations different types of solder joints may actually fall within different depth layers of the circuit board (which may increase the number of depth layers being processed by an inspection system). Only one depth layer corresponding to each side of circuit board 400 is shown in this example for simplicity and ease of illustration, but in actual application a plurality of depth layers may be of interest on each side of circuit board 400. While it may be useful in certain applications to have a 3D image of each solder joint, generally image planes 410 and 412 provide sufficient information to determine that each component lead is present and/or provide useful information for inspection of the various solder joints (e.g., inspection of the quality of such solder joints).

According to various embodiments of the present invention, 2D radiographic image data (pixels) of an object under inspection (e.g., circuit board 400) may be captured by a radiographic imaging system, such as those described above, and input to an image reconstruction processor. The image reconstruction processor processes the captured 2D radiographic image data to construct 3D (voxel) image data of the object, such as the example cross-sectional images described above in conjunction with FIGS. 3A-3D. Once produced, the 3D images of the solder joints of board 400 (or other portions of an object under inspection) may, in certain implementations, be automatically evaluated by the automated inspection system to determine their quality and physical characteristics, including, for example, solder thickness. Based on an evaluation by the inspection system, a report of the solder joint quality and physical characteristics and/or the reconstructed cross-sectional images of the solder joints may presented to the user.

It is to be understood that the term “image” (or “image data”) is not limited to formats which may be viewed visually, but may also include digital representations that may be acquired, stored, and analyzed by the computer. Thus, the term “image” (or “image data”), as used herein, is not limited to a viewable image, but is intended to also encompass computer data that represents the image and/or that may be processed by a computer for displaying a viewable image. For instance, in certain embodiments, the reconstructed 3D images (e.g., cross-sectional images) may be displayed to a user for inspection by such user in addition to or instead of automated inspection by the computer. In other embodiments, the reconstructed 3D images may not be displayed to a user, but instead the 3D image data may be autonomously analyzed by the computer for quality control.

Embodiments of the present invention utilize an iterative technique for processing 2D radiographic image data for reconstructing 3D image data therefrom. The conjugate gradient method (CG) is a well-known and very popular iterative method for solving large systems of linear equations. CG is effective for systems of the form Ax=b, wherein x is an unknown vector, b is a known vector, and A is a known, square, symmetric, positive-definite (or non-negative) matrix. Iterative methods like CG are suited for use with sparse matrices. The conjugate gradient method is described more fully in many mathematics texts, including an article titled “An introduction to the Conjugate Gradient Method Without the Agonizing Pain” by Jonathan Richard Shewchuk, School of Computer Science, Carnegie Mellon University, Pittsburgh, Pa. 15213 (Aug. 4, 1994), the disclosure of which is hereby incorporated herein by reference (and a copy of which is available via the world-wide web as of the filing of this application at http://www.cs.cmu.edu/˜quake-papers/painless-conjugate-gadient.ps).

The CG method has been proposed for use in 2D tomography. More specifically, Elena Loli Piccolomini and Fabiana Zama proposed using the CG method for 2D tomography in an article titled “The Conjugate Gradient Regularization Method in Computed Tomography Problems”, Department of Mathematics, University of Bologna, Italy, published in Applied Mathematics and Computation, vol. 102, pages 87-99 (1999), the disclosure of which is hereby incorporated herein by reference. That is, Elena Loli Piccolomini and Fabiana Zama proposed using the CG method for processing captured 1D image data for reconstructing 2D image data therefrom.

However, it was not readily apparent from the work by Piccolomini and Zama whether the CG method was extendable to 3D image reconstruction. The regularization term γ∥Lx∥ (See Equation 11 below) enables the CG method to work for the tomographic problem. It is well known that the regularization, even expressed by the same formula but applied for spaces with different dimensionality, may work in a very different way. As it was shown in the above article of Piccolomino and Zama, in the case of 2D image reconstruction, after some number of iterations (before the CG method starts diverging) the quality of the resulting 3D images was on par with the standard FBP or Radon's method. However, it was not clear from the work of Piccolomini and Zama whether the CG method would likewise work for 3D image reconstruction. For instance, it was unclear how many iterations the CG method may take for the 3D case (to be practical) and what would be the resulting level of quality achievable. As discussed further below, I have discovered that the CG method is applicable for 3D image reconstruction from 2D image data with an acceptable number of iterations and resulting in good quality 3D images. More specifically, as described further below, with a proper regularization coefficient, y, an acceptable number of iterations of the CG method (e.g., typically 5 iterations in my experiments) provides a very good quality of 3D images. Having such a manageable number of iterations (e.g., 5 iterations) for 3D image reconstruction, the CG method, due to its computational simplicity and the (known) readiness to work on parallel processors, may be superior to other tomographic techniques for such technical applications as X-ray inspection of printed circuit boards, for example, that require very speedy computation to maintain the desired throughput. Further, the CG method, when applied to 3D image reconstruction, provides quality as good as it does for the 2D case (described in the above article by Piccolomino and Zama). And, it is on par with the standard 3D image processing methods, like FBP or Radon's method, but lacks the deficiencies of such standard techniques requiring very special spatial arrangements (e.g., very regular geometries in the imaging system and very regularly ordered capture of pixels for processing).

The CG method belongs to the family of gradient-based algorithms. In some sense the gradient-based methods utilize a straightforward mathematical approach to the problem of reconstructing 3D images from 2D images. Let x be a set of voxels describing the X-ray absorption properties of an object located between a point-like X-ray source and the X-ray registration device (or “sensor”, such as a CCD matrix, film, scintillator, etc). If one orders the voxels in a vector x, then the X-ray image can be written as
Px=f (1)
where f is a vector representing a 2D X-ray image (log value of pixels of the X-ray image are organized into the vector f) and P is a matrix of projection. In general, the dimensionality of the vector x, n=dim(x), is much larger than the dimensionality of the X-ray image, m=dim(f). As a result, one should use many X-ray images of the same volume, obtained from different points of view (i.e., images acquired at different angles of view), to have enough equations to find x. So, instead of Equation I above, one works with a set of equations
Pᵢx=fᵢ (i=1 . . . M) (2)
where M is the number of X-ray images involved in the calculation. Of course, the lower the value of M, the fewer number of 2D images that must be processed. Let ∥ ∥ be a norm which calculates a length of a vector (e.g., the sum of squares, or L₂ norm, which is used in the calculation below). Then, the solution of Equation 2 can be expressed as

$${min}_{x} {\sum }_{i = 1}^{i = M} ‖ {P}_{i} x - {f}_{i} ‖ \qquad ( 3 )$$

i.e., one is looking for such an x that minimizes the sum in Equation 3. The CG method may be utilized to solve such a minimization problem as that of Equation 3. Equation 3 may be rewritten for L₂ metric as:

$${min}_{x} {\sum }_{i = 1}^{i = M} {( {P}_{i} x - {f}_{i} )}^{T} ( {P}_{i} x - {f}_{i} ) \qquad ( 4 )$$

Then one can differentiate Equation 4 by x and get the following linear equation:

$${\sum }_{i = 1}^{i = M} {P}_{i}^{T} ( {P}_{i} x - {f}_{i} ) = 0 \qquad ( 5 )$$

Or, rewriting Equation 5 into the standard form with the unknown on the left side:

$${\sum }_{i = 1}^{i = M} {P}_{i}^{T} {P}_{i} x = {\sum }_{i = 1}^{i = M} {P}_{i}^{T} {f}_{i} \qquad ( 6 )$$

Finally, Equation 6 can be written as a standard linear equation:
Ax=b (7)
where

$$\begin{matrix}A = {\sum }_{i = 1}^{i = M} {P}_{i}^{T} {P}_{i} \\ b = {\sum }_{i = 1}^{i = M} {P}_{i}^{T} {f}_{i}\end{matrix} \qquad ( 8 )$$

The challenge then becomes to solve Equation 7 above. The dimensionality, n, of the vectors x and b, n=dim(x)=dim(b), for one field of view (FOV) (which may also be referred to herein as “angle of view”) in Agilent Technologies 5DX machine, typically 1024×1024 with about 128 layers in the Z-direction, would be on the order of 100 M. This means that matrix A comprises (100M)² elements. There is no way to invert the matrix by any existing mathematical tools. Even to store the matrix one needs 10⁸ Gbytes of memory. Thus, such 3D tomography approach has traditionally been unsuitable for many high-speed applications, such as use within industrial inspection systems having high-speed production lines.

The CG method provides a solution. This iterative method needs only to perform the calculation of

$$Ax = {\sum }_{i = 1}^{i = M} {P}_{i}^{T} {P}_{i} x ,$$

which can be conducted directly from the physical formulation of the problem, without even storing the matrices Pᵢ^{T}, P In certain embodiments, the P^{T} term in the above equations can be calculated on the fly (i.e., during run time of the image processing). More specifically, in certain embodiments the P^{T} term is a mathematical representation of the back projection, and thus can be easily calculated in accordance with techniques known to those of ordinary skill in the art.

The CG method is not the only iterative method that is known. Other iterative methods, such as the well-known steepest descent method, the Algebraic Reconstruction Technique (ART), and Simultaneous Algebraic Reconstruction Technique (SART) are also known and may be used in alternative embodiments of the present invention. However, the CG method is preferred because it is the only iterative method currently known (in theory) that guarantees the convergence for a limited number of iterations, n.

For example, the steepest descent (gradient method) might be used in alternative embodiments because the gradient in Equations 3 and 4 above can be calculated explicitly:

$$grad = \frac{\partial {\sum }_{i = 1}^{i = M} ‖ {P}_{i} x - {f}_{i} ‖}{\partial x} = {\sum }_{i = 1}^{i = M} {P}_{i}^{T} {P}_{i} x - {\sum }_{i = 1}^{i = M} {P}_{i}^{T} {f}_{i} = Ax - b \qquad ( 9 )$$

But, a major disadvantage of the steepest descent algorithm is in its practically observed very slow convergence, compared with the CG method. Thus, the steepest descent algorithm does not provide the 3D reconstruction as fast as the CG method, and the 3D reconstruction provided by the steepest descent algorithm may not be suitably fast for certain applications. The ART is also a well-known variety of the gradient family of algorithms, which incorporates steepest descent along components of vector x. However, it demonstrates a slow convergence as well compared to the CG method.

In general, the reason the CG method demonstrates much faster convergence than other iterative methods is in the intrinsic property of the CG method to explore and memorize the multidimensional subspaces, see e.g., explanation of CG at http://www.sic.ox.ac.uk/scr/sobev/iblt/chapter1/notes/node20.html (note that an error is present in formula 193 therein, with the correct formula being beta=delta1 delta0 and actual exit from computation is immediately after delta1 is calculated). Contrary to other “no memory” gradient algorithms, when the CG method progresses along new directions of descent it uses the knowledge for all subspaces that participated in the previous iterations.

Any attempt to apply a gradient algorithm, CG included, as described by Equation 3 above, without proper regularization, will fail. The reason is that, due to the ill-posed nature of the matrix A, the solution drifts to a nonphysical subspace with a lot of elements of x less than zero, and the whole restored volume x looks extremely noisy. Regularization is a well known concept of introducing additional (a priory) knowledge into existing equations. In the case of 3D tomography, it could include basic physical knowledge that the cross-sections cannot be negative, or that the restored cross-sections cannot sharply deviate between the neighboring points in the 3D space because the real object in their majority have a smooth spatial change in cross sections, as examples. The mathematical background was established in the 1950s in works of A. Tikhonov and V. Turchin, and now regularization methods are widely used in computing. A proper regularization can dramatically enhance the robustness of numerical solutions for many a priory systems of equations. The balance between the amount of introduced a priory knowledge and the information included in the basic equation is maintained by evaluating the “penalties” due to overuse of a priory knowledge. Among the standard techniques is the analysis of the so-called “L-curves,” which are explained further below. By analyzing the “knees” on L-curves, one can obtain an optimal regularization parameter. As discussed further below, for example, my initial experiments show that the first knee on the L-curve represents the best value for the regularization parameter, γ.

The stop criteria for the CG iterations may not be derived directly from the observed reconstruction of cross-sections, because the exact solution for the particular imaging system being used may be unknown. Therefore, the deviation between actual X-ray images and the “model” X-ray images obtained from the reconstructed cross-sections in 3D volume of the task may be observed to determine an optimal number of iterations. This is where the L-curve may provide vital information. With the regularization parameter chosen for a particular imaging system/task, the choice for the optimal number of iterations for the CG method may be obtained from the analysis of solutions for artificially created scenes, in which the geometry and cross-sections of all participating objects are known. So, one can observe the solutions across the iterations. By conducting experiments with different scenes, the optimal number of CB iterations can be derived, which happens to be 5 iterations in the 3D reconstruction experiements that I have conducted. Of course, the optimal number of iterations may be found to be more or less than 5 for other imaging systems/tasks, and any such number of CG iterations is intended to be within the scope of the present invention.

There is a variety of possible regularizations to the above problem, which enable the gradient algorithm to succeed in reconstruction of 3D images from 2D images. To select a regularization, one should also follow restrictions imposed by the nature of the minimization algorithm. The CG algorithm, in its standard form, assumes that operator A is a linear, nonnegative symmetric matrix. As a result, the best we have in hand for the CG method is the Laplacian operator, which suppresses the high frequency component of the solution. Written for the 1D case, the Laplacian operator, L, has the following form (from which the 3D-case is a straightforward generalization):

$$Lx = \vert \begin{matrix}⋯ & ⋯ & ⋯ & ⋯ & ⋯ & ⋯ & ⋯ \\ ⋯ & 1 & - 2 & 1 & 0 & 0 & ⋯ \\ ⋯ & 0 & 1 & - 2 & 1 & 0 & ⋯ \\ ⋯ & 0 & 0 & 1 & - 2 & 1 & ⋯ \\ ⋯ & ⋯ & ⋯ & ⋯ & ⋯ & ⋯ & ⋯\end{matrix} \vert ( \begin{matrix}⋯ \\ {x}_{1} \\ {x}_{2} \\ {x}_{3} \\ {x}_{4} \\ ⋯\end{matrix} ) \qquad ( 10 )$$

Equation 10 above shows the Laplacian operator for the 1D case, because the Laplacian operator can be easily shown as a matrix acting on a vector for the 1D case. In higher dimensionalities the Laplacian operator also can be expressed as a matrix, but because the arrangements of neighboring points in 2D or 3D space cannot be represented as a natural vector, the matrix will look like a sparse matrix, rather than the near diagonal one in the case of 1D geometry. For example, if the points in 3D space are numbered as in the example of FIG. 15, then the portion of the Laplacian operator acting on these points and centered at the point 1, will be as the following:

$$\begin{matrix}Lx = {X}_{2} - 2 {X}_{1} + {X}_{3} + {Y}_{2} - 2 {Y}_{1} + {Y}_{3} + {Z}_{2} - 2 {Z}_{1} + {Z}_{3} + \\ {X}_{7} - 2 {X}_{1} + {X}_{6} + {Y}_{7} - 2 {Y}_{1} + {Y}_{6} + {Z}_{7} - 2 {Z}_{1} + {Z}_{6} + \\ {X}_{5} - 2 {X}_{1} + {X}_{4} + {Y}_{5} - 2 {Y}_{1} + {Y}_{4} + {Z}_{5} - 2 {Z}_{1} + {Z}_{4}\end{matrix}$$

In this example, the so-called 6-point scheme is used to calculate the Laplacian, but there are many other well-known schemes that can be used instead. It should be appreciated that for the 3D case the regularization procedure involves more spatial points than in 2D case. This may partially explain why in the 3D case faster convergence (with only 5 iterations required) has been observed than that compared with the CG method applied in 2D case.

The regularized analog of Equation 3 has the form:

$${min}_{x} ( {\sum }_{i = 1}^{i = M} ‖ {P}_{i} x - {f}_{i} ‖ + γ ‖ Lx ‖ ) \qquad ( 11 )$$

where γ≧0 is the regularization parameter. The corresponding analog of Equation 7 will have a new, regularized, matrix A of the form

$$A = {\sum }_{i = 1}^{i = M} {P}_{i}^{T} {P}_{i} + γ {L}^{T} L \qquad ( 12 )$$

With γ=0, one has the original, unregularized equation, and with γ→∞ one has an equation with a constant as a solution. Potential values of the regularization parameter γ that may be utilized for the CG method in embodiments of the present invention for processing 2D images to reconstruct 3D images are described further herein below.

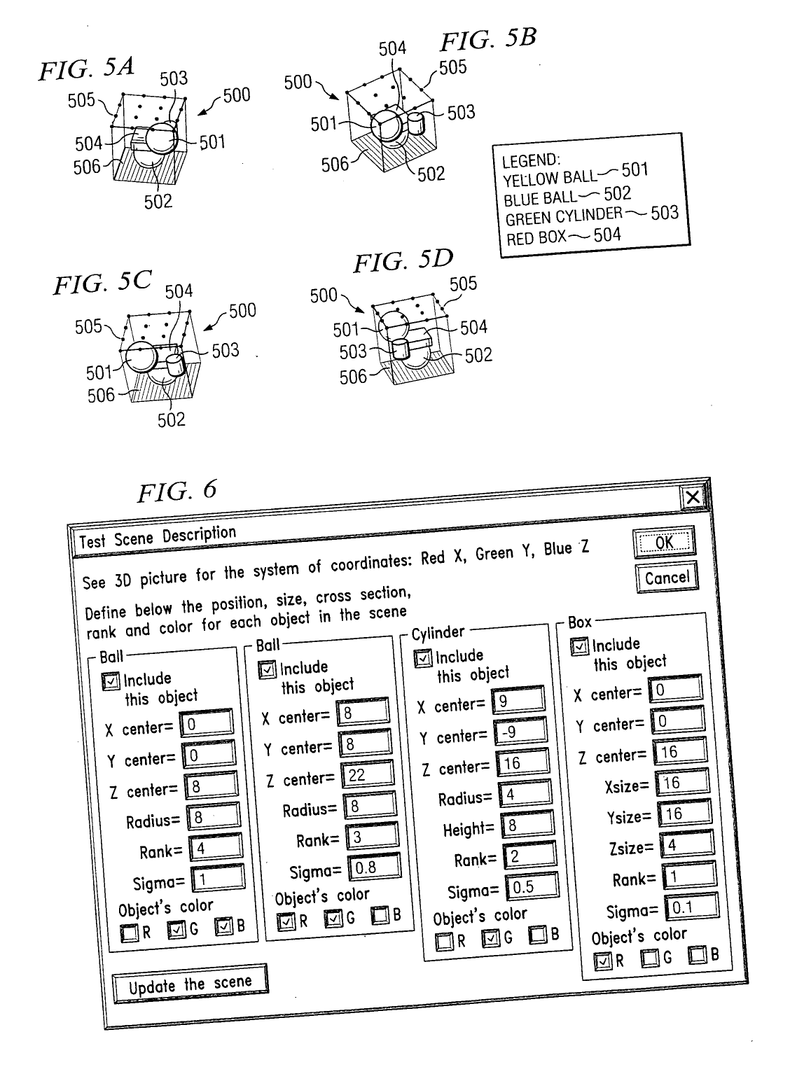

As an example, a test scene is shown in the example of FIGS. 5A-5D, wherein the test scene includes basic geometrical primitives commonly found in the inspection of circuit printed boards. The example test scene 500 comprises four geometrical primitives: two spheres 501 and 502, a cylinder 503, and a box 504. The primitives are combined into a compact group in which box 504 partially penetrates into spheres 501 and 502 and cylinder 503. But, as described below, a cross-section in the overlapped area is taken from the corresponding bodies, not from the box in this example. The scene's volume consists of 32*32*32 voxels in this example.

The exact locations, sizes, and X-ray cross-sections are shown in the dialog of FIG. 6. It should be noted that the primitives are also each assigned a rank in the dialog of FIG. 6. For instance, box 504 is assigned a rank of 1, cylinder 503 is assigned a rank of 2, ball 501 is assigned a rank of 3, and ball 502 is assigned a rank of 4. The rank of the primitives defines the cross-section for the volume where two or more primitives intersect each other: the cross-section is taken from the highest ranked primitive. For example, inside the volume where ball 501 intersects box 504, the cross section of ball 501 is taken as the cross section of the volume because such ball 501 has the (superior) rank 3, while box 504 has rank 1.

The scene 500 is illuminated by point-like sources 505 arranged at the top of the scene (4*4=16 sources 505 in this example). The X-ray sources 505 produce parallel beams going in the direction from the point sources 505 to the center of the bottom of the scene geometry (which comprises sensor(s) for capturing the resulting 2D image data). All other rays in the same beam are parallel to the guiding ray. A flat “registration plane” 506 is located at the bottom of the scene geometry, and contains a matrix sensors for capturing 32*32 pixels, in this example. In the overall design, the test scene geometry is similar to what one may expect in a real-life imaging device, such as the above-described cone-beam imaging devices, with illumination angles varying between 00 and 450. The compact location of spheres 501 and 502 represents the cases with ball grid arrays (BGAs), and box 504 represents the problem handling an object having parallel top and bottom surfaces. For example, if a box covers the whole span of the scene in the X and Y direction, generally speaking, there is no way one can recover the Z-position for the top and bottom surfaces of the box. In our case, the box covers only a part of the X-Y span, but it still has a size big enough to challenge the algorithm.

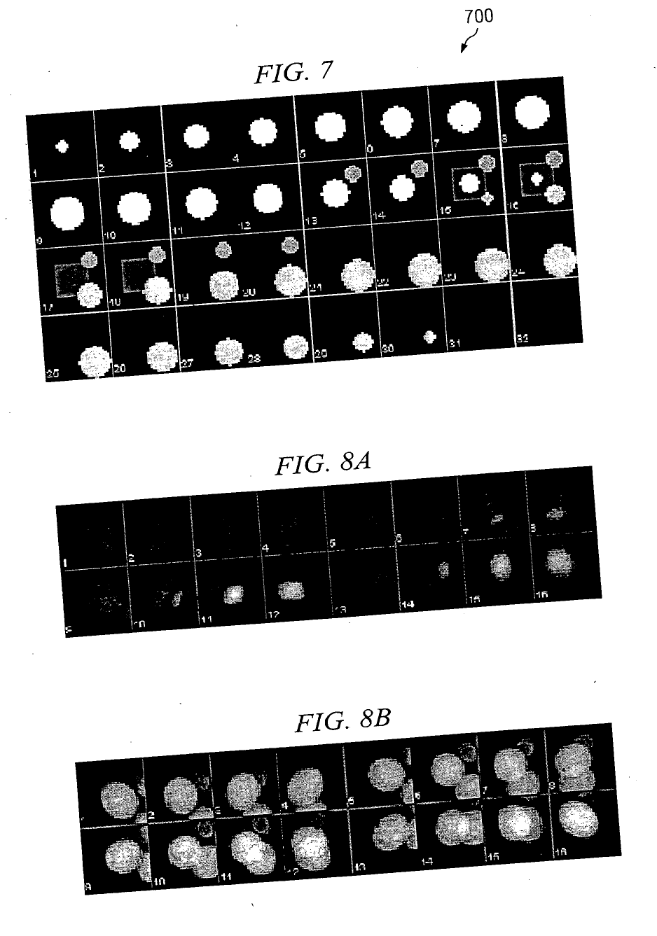

To show the result of computation, the 3D volume is represented by 2D slices. In my example case 32 slides combined into a tile 700, as shown in FIG. 7. The brighter the image, the higher the X-ray absorption in the cross-section. Cross-sections of example scene 500 are represented by 32 slices in the Z-direction, starting from the bottom of the scene (shown as slide 1 in tile 700). To make the box 504 clear visible, the picture is calculated as the log-normalized one from the original (linear density) picture, in which the cross-section for the box 504 looks dim. Special normalizations (like the log-norm in this example) are often used to improve the visibility of details in the picture.

The goal of 3D tomography is to reconstruct 3D image data (e.g., 3D cross-sections, such as shown in tile 700 of FIG. 7) from a set of 2D X-ray images captured by registration plane 506. In this test geometry, the 2D X-ray images are as shown in FIGS. 8A and 8B. FIGS. 8A and 8B each shows a set of 2D X-ray images obtained from 16 different directions of X-ray beams (16 different “angles of view” or “fields of view”) by registration plane 506. FIG. 8A is shown in the linear scale, and FIG. 8B is shown after the log-norm transformation highlighting the projection of box 504, which is poorly visible in the linear-scaled images of FIG. 8A.

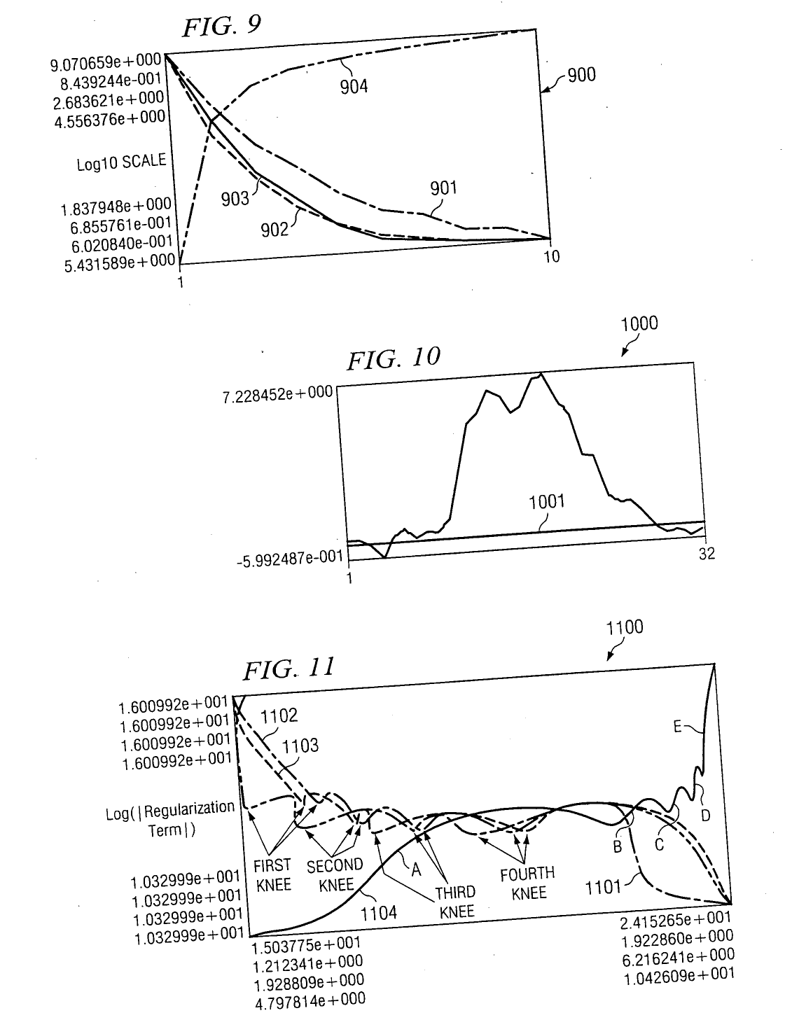

In a preferred embodiment, the CG algorithm is used for processing the captured 2D X-ray images for reconstructing 3D images therefrom. As described above, the CG algorithm is an iterative algorithm. The graph of FIG. 9 shows the progress of the CG algorithm after each step of iteration. To explain the curves in the graph of FIG. 9, an excurse into an example of actual implementation of the CG method is considered. The following pseudo-code describes an example implementation of the CG algorithm in accordance with an embodiment of the present invention:
Compute r₀=d₀=b−A*x₀ for an initial guess x₀
for j=0,1, . . . , until convergence
   αⱼ=(rⱼ, rⱼ)/(Adⱼ, dⱼ)
   xⱼ₊₁=xⱼ+αⱼ dⱼ
   rⱼ₊₁=rⱼ−αⱼ Adⱼ
   βⱼ=(rⱼ, rⱼ₊₁)/(rⱼ, rⱼ)
   dⱼ₊₁=rⱼ₊₁βⱼ dⱼ
endfor.
where (,) is the dot product. Two auxiliary vectors, r, d, have the same size as vector x. Due to the fact that the exact solution, x, (in other words: the cross-sections, or volume) is not known, one should test the convergence indirectly. Usually the test is based on the value of the residual vector, r. So, curve 901 on graph 900 of FIG. 9 is equal to (r,r). Curve 902 shows the average square difference between actual 2D X-ray images, f, and the 2D X-ray images produced by the restored

$${\sum }_{i = 1}^{i = M} {( {P}_{i} x - {f}_{i} )}^{2} .$$

Curve 903 shows the average squared difference between the right side of the equation and the restored x, i.e. (Ax−b)². And finally, curve 904 represents the average difference between exact solution, x_{exact}, which is known for the model, and the current x from the CG method, i.e. (x_{exact}−x)².

It is a known problem of the CG method when one attempts to use it for the 2D tomographic restoration that the method diverges in x space, as recognized by Elena Loli Piccolomini and Fabiana Zama in “The Conjugate Gradient Regularization Method in Computed Tomography Problems”, Department of Mathematics, University of Bologna, Italy, published in Applied Mathematics and Computation, vol. 102, pages 87-99 (1999), the disclosure of which has been incorporated herein by reference. In view of the above, we have recognized that the divergence manifests itself when the CG method is used in 3D tomography, as well.

Because the method converges fairly well on the model geometries in the space of X-ray images (curve 902), the simultaneous divergence in x space is just a manifestation of the fact that the linear system is ill-posed. Unfortunately, if one increases the number of X-ray images involved, there is still no guarantee of convergence in x space. Thus, a question in the CG method becomes: could one get the convergence of cross-sections having a large enough set of 2D X-ray images obtained from different directions (i.e., obtained from different angles of view)? But, even if such a set exists, it could require too much computational time to be practically useful for the industrial inspection environment (e.g., for inspecting PCBs and/or other devices). That is, too many iterations of the CG method may be required for achieving the convergence to enable the CG method to be practically useful in high-speed 3D image reconstruction environments, such as many industrial inspection environments and certain medical applications that need high-speed processing. The major manifestation of the divergence is the following: as the number of iterations progresses, the CG algorithm tends to migrate into areas with negative values in vector x, which has no physical sense indeed. (The problem is also observed in the ART family of iterative methods).

The example graph of FIG. 10 demonstrates the observed migration of the solution into non-physical (negative) cross-sections. Horizontal line 1001 on graph 1000 of FIG. 10 shows the zero level. The values below such line 1001 are non-physical. Unfortunately, it appears that positiveness cannot be imposed on the vector x by a linear operator.

Choosing the regularization parameter, y, sets the balance between minimizing the residual norm

$${\sum }_{i = 1}^{i = M} ‖ {P}_{i} x - {f}_{i} ‖$$

and minimizing the “roughness” ∥Lx∥ (See Equation 11 above). A convenient graphical tool for setting γ is the “L-curve”. When one plots log

$${\sum }_{i = 1}^{i = M} ‖ {P}_{i} x - {f}_{i} ‖$$

versus log ∥Lx∥ a characteristic L-shaped curve with a (often) distinct corner separating vertical and horizontal parts of the curve is obtained. The rationale for using the L-curve is that regularization is a trade-off between the data misfit and the accuracy of solution. In the vertical part of the curve, the solution norm

$${\sum }_{i = 1}^{i = M} ‖ {P}_{i} x - {f}_{i} ‖$$

is a very sensitive function of the regularization parameter because the solution is undergoing large changes with γ in an attempt to fit the data better. At these low levels of filtering by the smoothing matrix, L, there are still components in the solution which come from dividing by a small singular value in the matrix

$${\sum }_{i = 1}^{i = M} {P}_{i}^{T} {P}_{i}$$

(see Equation 12 above), which corresponds to having inadequate regularization.

On the horizontal part, the solutions are not changing by very much as γ is changed. However, the data misfit increases sharply with more filtering. Along this portion, the preference for the more highly filtered solutions increases only slightly at the cost of a rapidly rising data misfit. FIG. 11 shows graph 1100 that shows an example L-curve that is associated with the tomographic restoration in the CG method of an embodiment of the present invention. More specifically, FIG. 11 shows an L-curve for the CG-method calculated for 5 iterations for the test geometry (of FIG. 5), and covering the regularization parameter, γ, between 0.01 and 1000. For each regularization parameter, along the Y-axis of graph 1100 the corresponding log of the regularization term is plotted, and along the X-axis of graph 1100 different norms of convergence are plotted.

There are four graphs plotted in graph 1100 which show the L-curve for different values. Curve 1101 represents the residual, r (as with curve 901 of FIG. 9); curve 1102 shows the difference between actual 2D X-ray images, f, and the 2D X-ray images produced by the restored x:

$${\sum }_{i = 1}^{i = M} {( {P}_{i} x - {f}_{i} )}^{2}$$

(as with curve 902 of FIG. 9); curve 1103 shows the difference between the right side of the equation and what comes from the restored x, i.e. (Ax−b)² (as with curve 903 of FIG. 9); and finally, curve 1104 shows the difference between the exact solution, x_{exact}, which is known for the model, and the solution x from the CG method, i.e. (x_{exact}−x)² (as with curve 904 of FIG. 9). If curves 1101, 1102, and 1103 behave in accordance with the classical L-curve, curve 1104, is kind of symmetrically reflected due to the observed divergence of the CG method in the space of restored cross-sections.

As experiments show, the number of “waves” on the L-curve 1104 is equal to the number of iterations for the CG method: 5 iterations in the example plotted case of FIG. 11 with L-curve 1104 thus having 5 waves (labeled A, B, C, D, and E, respectively in FIG. 11). The best visual quality of restoration of the cross-sections corresponds to γ=1.0, which, in turn, corresponds to the first knee calculated from the left to the right side of graph 1100 for curves 1101, 1102, and 1103, or for the first knee calculated from the right side of graph 1100 for L-curve 1104. Graph 1100 covers the span of γ between 0.01 and 1000.

As described further below, the quality of the resulting 3D images using the above-described CG method is very good, generally being much better quality than achieved through tomosynthesis. While the observed divergence is a problem for a big number of iterations, an advantage of the CG method is its superior 3D resolution in cross-section images achieved just after very few iterations (˜5) compared with the ART technique and tomosynthesis (e.g., traditional techniques not using exact solutions of equations). So, by properly choosing the number of iterations to be performed, the divergence problem can be alleviated. And, a large number of iterations is typically not desired in any case, because the computation time is directly proportional to the number of iterations.

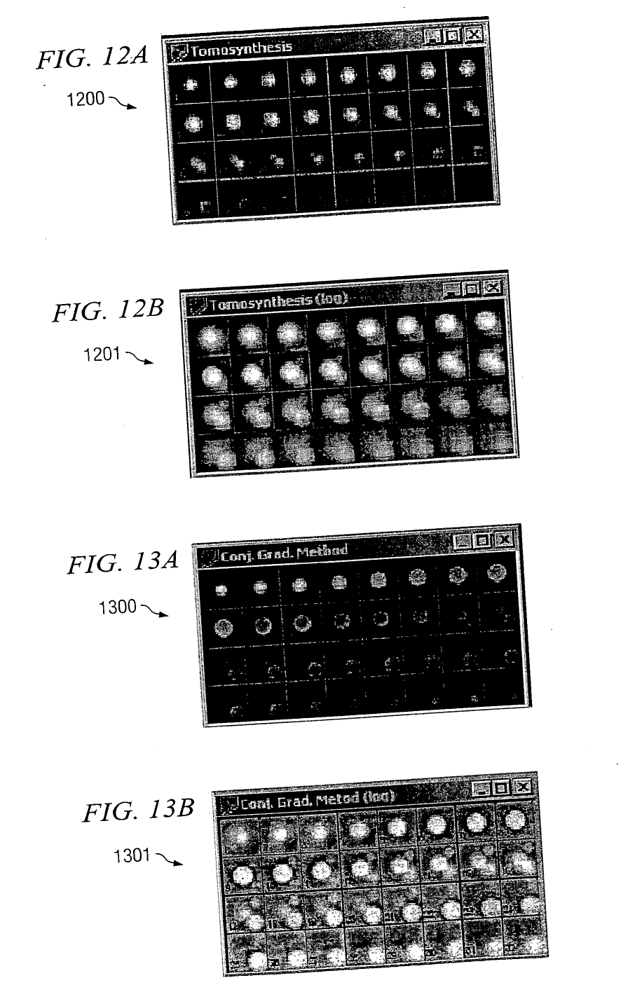

FIGS. 12A-12B and 13A-13B provide a visual comparison of the results obtained through the CG method (after 5 iterations) and the results obtained via tomosynthesis technique that does not use an exact solution of equations for the example scene of FIGS. 5A-5D. More specifically, FIG. 12A shows a tile 1200 that comprises 32 slices resulting from a tomosynthesis technique. FIG. 12B shows tile 1201 that comprises the 32 slices of FIG. 12A with log brightness normalization having been applied thereto. FIG. 13A shows a tile 1300 that comprises 32 slices resulting from an example CG processing method of an embodiment of the present invention, and FIG. 13B shows tile 1301 that comprises the 32 slices of FIG. 13A with log brightness normalization having been applied thereto. Tiles 1200, 1201, 1300, and 1301 each represent a 3D volume of the scene 500 of FIGS. 5A-5D by slices taken perpendicular to the Z-axis at different heights along the Z-axis. The 32 slices are numerated (left, bottom) in each tile, and are counted from the bottom of the volume (i.e., slice 1 corresponds to a bottom cross-section below slice 2 along the Z-axis, and so on).

As can be seen in this example, the 3D images resulting from the CG processing technique are much sharper and do not have the smooth spatial variations in the restored cross-sections typical for the tomosynthesis technique. The resolution in the Z-direction resulting from the CG processing technique is also better than in the tomosynthesis technique.

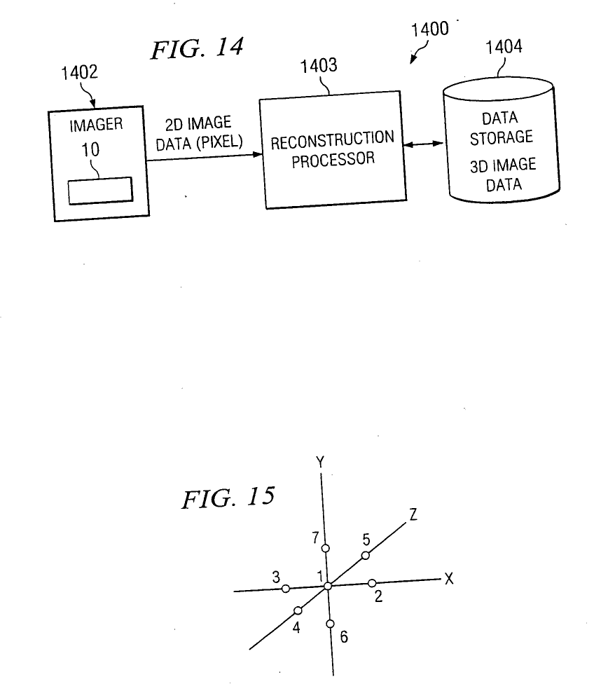

Turning to FIG. 14, an example high-level block diagram is shown for a system implementing a 3D image reconstruction process of an embodiment of the present invention. In the example of FIG. 14, inspection system 1400 comprises a radiographic imaging system 1402, which may, for example, be a cone-beam tomographic imaging system such as described above with FIG. 1. Radiographic imaging system 1402 is preferably a digital-based imaging system that captures 2D radiographic images of an object 10 (e.g., a circuit board). Reconstruction processor 1403 is communicatively coupled to radiographic imaging system 1402 such that it can receive 2D radiographic image data (or “pixels”) from imager 1402. Reconstruction processor 1403 is also communicatively coupled to data storage (or “memory”) 1404 which is used to store reconstructed 3D (e.g., cross-sectional) image data. Data storage 1404 may comprise any suitable data storage device now known or later discovered for storing reconstructed 3D image data, including as examples random access memory (RAM), disk drives, floppy disks, optical discs (e.g., Compact Discs (CDs) and Digital Video Discs (DVDs)), and other data storage devices. Data storage 1404 may be integrated with reconstruction processor 1403 (e.g., on-chip memory) or it may be external thereto.

As described above, in accordance with embodiments of the present invention reconstruction processor 1403 may implement an iterative processing technique, such as a CG method, for processing the 2D image data to reconstruct 3D image data therefrom. Reconstruction processor 1403 may be implemented as the reconstruction processor disclosed in co-pending U.S. patent application Ser. No. ______ [Attorney Docket No. 10020619-1] titled “A SYSTEM AND METHOD FOR PARALLEL IMAGE RECONSTRUCTION OF MULTIPLE DEPTH LAYERS OF AN OBJECT UNDER INSPECTION FROM RADIOGRAPHIC IMAGES”, the disclosure of which is hereby incorporated herein by reference. Accordingly, in certain implementations, reconstruction processor 1403 may be implemented to process multiple depth layers of object 10 in parallel, such as disclosed in U.S. patent application Ser. No. ______ [Attorney Docket No. 10020619-1] titled “A SYSTEM AND METHOD FOR PARALLEL IMAGE RECONSTRUCTION OF MULTIPLE DEPTH LAYERS OF AN OBJECT UNDER INSPECTION FROM RADIOGRAPHIC IMAGES”, wherein an iterative processing technique, such as a CG algorithm may be used for performing such processing in accordance with embodiments of the present invention. Further, in certain implementations, reconstruction processor 1403 may actually comprise a plurality of processors that execute in parallel for reconstructing 3D images of object 10 from 2D radiographic images received from imager 1402, wherein such plurality of processors may each utilize an iterative processing technique, such as a CG algorithm for such processing in accordance with embodiments of the present invention.

Embodiments of the present invention may be implemented as a combination of hardware and firmware (or circuitry) that receives as input 2D radiographic (e.g., X-ray transmissive) image data for at least a portion of an object and reconstructs 3D (e.g., cross-sectional) image data corresponding therefrom using an iterative processing technique, such as a CG algorithm. A preferred embodiment comprises a hardware architecture that includes a processor unit such as a Field Programmable Gate Array (FPGA) or an Application Specific Integrated Circuit (ASIC). Thus, reconstruction processor 1403 of FIG. 14 is preferably implemented as part of a larger processor unit such as an FPGA or ASIC. Various other configurations now known or later developed for implementing a reconstruction processor for processing 2D image data to reconstruct 3D image data therefrom in accordance with embodiments of the present invention may be used in alternative embodiments.

In view of the above, in operation of a 3D tomographic system implementing the CG method, one may implement a CG method for iteratively processing 2D image data for reconstructing 3D image data therefrom. More specifically, one may select a regularization parameter (which may be determined from the L-curve in the manner described above), select an optimal number of iterations to be performed for the particular imaging geometry and/or object being imaged by such system (wherein such optimal number of iterations may be selected from a lookup table of previously determined iterations that are optimal for a given type of imaging geometry and/or object being imaged), and then use the CG method for iteratively processing 2D images received from a radiographic imaging device to construct 3D images.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for processing 2D image data for reconstructing 3D image data therefrom, the method comprising:
receiving a plurality of 2D images acquired at different angles of view; and
iteratively processing the received 2D images to reconstruct 3D image data therefrom.

2. The method of claim 1 wherein said 3D image data comprises at least one cross-section of an object under inspection.

3. The method of claim 1 wherein said iteratively processing comprises:
processing the received 2D images in accordance with a conjugate gradient algorithm.

4. The method of claim 1 wherein the 2D images are not required to be received in a pre-defined order.

5. The method of claim 4 wherein said iteratively processing comprises:
processing said 2D images as they are received.

6. The method of claim 4 wherein said iteratively processing comprises:
processing 2D images in the order in which they are received.

7. The method of claim 1 further comprising:
determining an optimal regularization parameter.

8. The method of claim 7 further comprising:
using the determined optimal regularization parameter in said iteratively processing.

9. The method of claim 7 wherein said determining an optimal regularization parameter comprises:
using an L-curve to determine the optimal regularization parameter.

10. The method of claim 1 further comprising:
determining an optimal number of iterations to perform in said iteratively processing.

11. The method of claim 10 wherein said determined optimal number of iterations is a suitably small number of iterations to enable efficient processing by said iteratively processing.

12. The method of claim 11 wherein said determined optimal number of iterations comprises 5 iterations.

13. The method of claim 1 further comprising:
a radiographic imaging system capturing said plurality of 2D images at said different angles of view for an object under inspection.

14. The method of claim 13 wherein said radiographic imaging system uses cone-beam tomography to capture said plurality of 2D images.

15. A system for processing 2D image data for reconstructing 3D image data therefrom, the system comprising:
means for receiving a plurality of 2D images acquired at different angles of view; and
means for iteratively processing the received 2D images to reconstruct 3D image data therefrom.

16. The system of claim 15 wherein said means for iteratively processing comprises:
means for processing the received 2D images in accordance with a conjugate gradient algorithm.

17. The system of claim 15 wherein said means for iteratively processing does not require that the received 2D images be received in a pre-defined order.

18. A system for processing 2D image data for reconstructing 3D image data therefrom, the system comprising:
an imaging system operable to capture a plurality of 2D images at different angles of view; and
a reconstruction processor communicatively coupled to the imaging system, said reconstruction processor operable to receive the plurality of captured 2D images and iteratively process the received 2D images to reconstruct 3D image data therefrom in accordance with a conjugate gradient algorithm.

19. The system of claim 18 wherein the reconstruction processor does not require the 2D images to be received in a pre-defined order.

20. The system of claim 18 wherein the reconstruction processor does not require a pre-defined order of capturing said different angles of view.
